(19) United States
(12) Patent Application Publication
(10) Pub. No.: US 2012/0089482 A1
(43) Pub. Date: Apr. 12, 2012

(54) LAST-ROOM-AVAILABLE SEARCH APPARATUS AND METHOD

(76) Inventor: Narendra Patel, San Antonio, TX (US)

(21) Appl. No.: 13/267,844

(22) Filed: Oct. 6, 2011

Related U.S. Application Data
(60) Provisional application No. 61/390,250, filed on Oct. 6, 2010.

(51) Int. Cl. G06Q 30/06

(52) U.S. Cl. 705/26.41; 705/27.1; 705/26.9

(57) ABSTRACT

A system and method for customer-oriented searching and purchasing of goods and services relies on a database having records corresponding to purveyors, products and services, and purchasers and maintained by a third party independent from all the foregoing. Searches may obtain information with or without cooperation of purveyors (vendors). Filtering before presentation to a user, according to specific needs or requirements eliminates inapplicable vendors, products, or services. Particularly, if quality rating, features, or actual availability is lacking, the system does not waste a user's time to evaluate. Deal-killer parameters and values punish vendors lacking disclosure. Rather than publish what the seller wants to advertise, the system retrieves for a user the information on items that meet criteria of, and according to their importance to, a user, especially deal-killer parameters.

### RELATED APPLICATIONS

This application claims the benefit of co-pending U.S. Provisional Patent Application Ser. No. 61/390,250, filed Oct. 6, 2010 for AUTOMATED ELECTRONIC TRAVEL AGENT.

### BACKGROUND

1. The Field of the Invention

This invention relates to software and, more particularly, to novel systems and methods for searching, filtering, and presenting reservation information for lodging.

2. The Background Art

Online purchasing of goods and services is known in the art, resulting in users becoming exceedingly frustrated at the lists of information that turns out to be ultimately useless to the purchaser. Who has not gone online to find lodging and found at the end of a seemingly endless reading of advertising materials, viewing of rooms, selection of features, review of rates, and the like that the room or other accommodation desired is not available.

Online purchasing is by nature very advertising oriented. It is not typically purchaser oriented. Sellers try to promote what benefits them, and this approach is directly contrary to the point of view of the buyer. For example, sellers evidently want to promote their brands of products and services only. They appear to have no apparent interest in the customer, unless and until the purchaser is their customer.

In contrast, a purchaser may be browsing, but is often more interested in something to solve an immediate, recognizable, often urgent problem. The customer, purchaser, computer user, or user wants a solution, and rapidly. There is no one really interested in solving the user's problem, only in presenting the sellers solutions to as many potential users as possible. Web sites of sellers give statistics on every type of product, organized by product. They show every type of accommodation.

Even web sites that claim to be brokerages operate the same way, only with more brands offered. Each still has the same problem. Moreover, brokerage types of web sites usually impose tremendous risk, requiring blind bidding, blind commitments, flexibility of time or time, and so forth. This helps make a match but does so at the sacrifice of one or more requirements a user purchaser must give up. Many computer users making such purchases or reservations cannot give up the required elements necessary to work with brokerage types of sites. Those who have done so often have disastrous results. Stories abound wherein airplane, hotel, or other reservations purchased turn out to be completely unsuitable for the very purpose for which purchased.

Buying exactly what is offered is not a problem if one buys early. For example, obtaining lodging reservations well in advance, at full price, from a known “brand name” purveyor of such services, at a known site of that purveyor, is not a problem. Restrict any of those conditions, and the problems begin. What happens if one has less time, like needing a room today, right now? What happens if the big names are not close, or are full? What happens when the location of meetings is fixed, and one needs a hotel close by? What happens when one has a choice of two or twenty hotels, and each attempt shows the selected type of room is not available? The time required to obtain a reservation is substantial under such conditions, or often under any one of those conditions.

In short, who can argue with the impossibility of finding and reserving lodging in an unfamiliar city with suitable price, quality rating, cleanliness, services offering, proximate to specific venues, accessible to public transportation, having other specific and desired features, and availability?

Customers who want to rapidly find a suitable solution are frustrated for several reason, but at least one more requires mention. The solution desired by a computer user as a purchaser, particularly for lodging or other travel services, is unique to that purchaser. For example, every purchaser may represent a unique combination of familiarity with a city, suitability of price, desired quality rating, standards of cleanliness, standard of service, services offered, necessary assistance, proximity to specific venues, accessibility to public transportation, other specific and desired features, and the immediacy of availability.

What is needed is travel services oriented to solving the needs and circumstances of the purchaser (user, consumer, buyer, customer) rather than those of a particular purveyor (seller, dealer, carrier, hotelier, equipment rental agency, car rental agency, etc.).

### BRIEF SUMMARY OF THE INVENTION

In view of the foregoing, in accordance with the invention as embodied and broadly described herein, a method and apparatus are disclosed in one embodiment of the present invention as including a method comprising providing a processor corresponding to a first computer, providing a medium operating as a computer-readable storage medium, operably connected to the processor, and selecting a network configured to interconnect computers for inter-computer communication. The method then includes connecting the first computer to the network to communicate with a second computer corresponding to a purchaser. Connecting the first and second computers over the network may be followed by storing on the medium executables executable by the processor.

Presenting by the second computer an image corresponding to a user interface is then followed by receiving through the user interface a request for a product, comprising at least one of goods and services. Receiving may also further include receiving a value of a filter parameter, the filter parameter reflecting at least one of a rating for quality and actual availability.

Next, searching published information from purveyors of the product determines candidate purveyors each corresponding to an instance of a third computer. Filtering the candidate purveyors based on the filter parameter determines responsive purveyors complying with the filter parameter. Therefore, presenting to the user computer the product available from the responsive purveyors a user may complete a transaction, having eliminated all non-compliant and non-available products advertised.

The method may include selecting by a user a selected purveyor from the responsive purveyors. Sometimes the method includes contacting, by the second computer, a third computer corresponding to the selected purveyor. Selecting by the second computer a first location selected from the current location of the second computer and a future location identified, by the user, to the second computer is often a user choice allowing instant searching from the user location, or for a planned future location.

The method may include displaying on the second computer a map, provided from the first computer and illustrating an indicator identifying locations of advertised purveyors advertising the product and located within a selected portion of the map with respect to the first location. Likewise, it may involve providing by the second computer to the first computer a deal-killer parameter reflecting a requirement selected by a user as non-negotiable.

Filtering often includes deleting from the displaying all candidate purveyors not complying with a threshold value selected by the user for the deal-killer parameter. Thus the deal-killer parameters may be at least one of rating, current availability, and cost.

The system may contact, by the second computer, the third computer corresponding to the selected purveyor, automatically upon selection of the selected purveyor by the user. It may store, typically by the second computer, for inputting automatically to the third computer, also by the second computer, user information effective to complete a commercial transaction between the user and the selected purveyor for exchange of the product.

In one embodiment, an article includes a computer readable storage medium storing data structures comprising executables executable on a processor and operational data. The data structures may include a user interface module for communicating with a user computer. Also available is a database storing records corresponding to products and purveyors of the products. A crawler provides to the database, automatically, purveyor data and product data published by the purveyors. A filter module has filter parameters and is programmed to receive values reflecting criteria selected by the user computer. The filter module may be further programmed to limit purveyors identified to the user computer according to the values.

The user interface module may be programmed to display to a user compliant purveyors, a subset of the purveyors based on the criteria. Therefore, a transaction module may be programmed to execute a transaction between the user computer and a purveyor computer based on a selection by the user from the compliant purveyors.

Other modules may include a tracker module monitoring and tracking purchases transacted by the transaction module, a butler module saving information corresponding specifically to transactional data corresponding to purchaser, and a ratings filter effective to filter records from the database in accordance with quality rating values input to the user interface.

Very valuable, an availability filter is effective to prevent the user interface from presenting to a user at least one of advertising and transaction information corresponding to a purveyors based on the values. It may also be effective to prevent presentation to the user interface module information corresponding to purveyors not satisfying the values. Likewise, it may prevent transactions by the user interface module and a purveyor computer, based on the values.

In some embodiments, at least one of preference filters and profile filters may be executable to control selection of purveyor records from the database and presented to the user interface based on at least one of purchaser inputs received by the user interface from a purchaser and user purchase history data obtained from previous transactions completed by the user interface module. Also, a tracker module monitoring transactions completed by the user interface module may save that information for future transactions and modifying profiles and preferences.

An apparatus may include a first computer comprising a processor operably connected to a memory, the processor creating, hosting, and operating a database having records stored in the memory, as well as a second computer, corresponding to a user and operably connected over a network to the first computer. A plurality of third computers corresponding to purveyors of a product present information corresponding to the product.

The first computer may be programmed to create product records and purveyor records in the database containing information obtained by the first computer from the plurality of third computers, and programmed to provide a plurality of filters capable of receiving filter values corresponding thereto selectable by the second computer to control searches of the records.

Likewise, the first computer may be programmed to provide to the second computer access to the database, provide criteria and user values selected by a user as the filter values, and provide to the second computer identification of candidate purveyor computers in accordance with the filter values. It may receive from the second computer selection data selecting a selected purveyor computer from the candidate purveyor computers. The second computer may provide the filter values corresponding to at least one of quality rating and actual availability. It may also delete from presentation to the second computer presentation of the purveyor information not corresponding to the candidate purveyors and the product.

In one aspect, an automated electronic travel agent is disclosed. An automated electronic travel agent may be embodied as a handheld device with a GPS receiver and wireless internet access and programmed with travel agent functions. The automated travel agent displays, for example, nearby hotels and motels that list vacancies via a third-party service provider. Proximity to hotels and motels is determined by the GPS receiver. Communication with the third-party service provider is enabled by means of the wireless the wireless network interface. To enhance the commercial viability of the automated electronic travel agent, banner advertisements may be displayed in conjunction with room vacancies.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a schematic block diagram of a computer, its contents, and the networks and other computers, including servers and routers, suitable to implement a method and apparatus in accordance with the invention;

FIG. 2 is a schematic block diagram of one embodiment of a process executable on a system in accordance with FIG. 1 in accordance with the invention;

FIG. 3 is a schematic block diagram of one embodiment of executables, computer instructions stored in a computer readable storage medium (memory) in accordance with the apparatus of FIG. 1 in order to implement various embodiments of an apparatus and method in accordance with the invention;

FIG. 4 is a front view of an exemplary embodiments of a handheld device configured to function as an automated electronic travel agent;

FIG. 5 is a block diagram drawing of the handheld device of FIG. 4 disclosing exemplary components that may be used in the construction of an automated electronic travel agent; and

FIG. 6 is a network-level diagram of an automated electronic travel agent connected to a network.

### DETAILED DESCRIPTION OF THE PREFERRED EMBODIMENTS

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, as claimed, but is merely representative of various embodiments of the invention. The illustrated embodiments of the invention will be best understood by reference to the drawings, wherein like parts are designated by like numerals throughout.

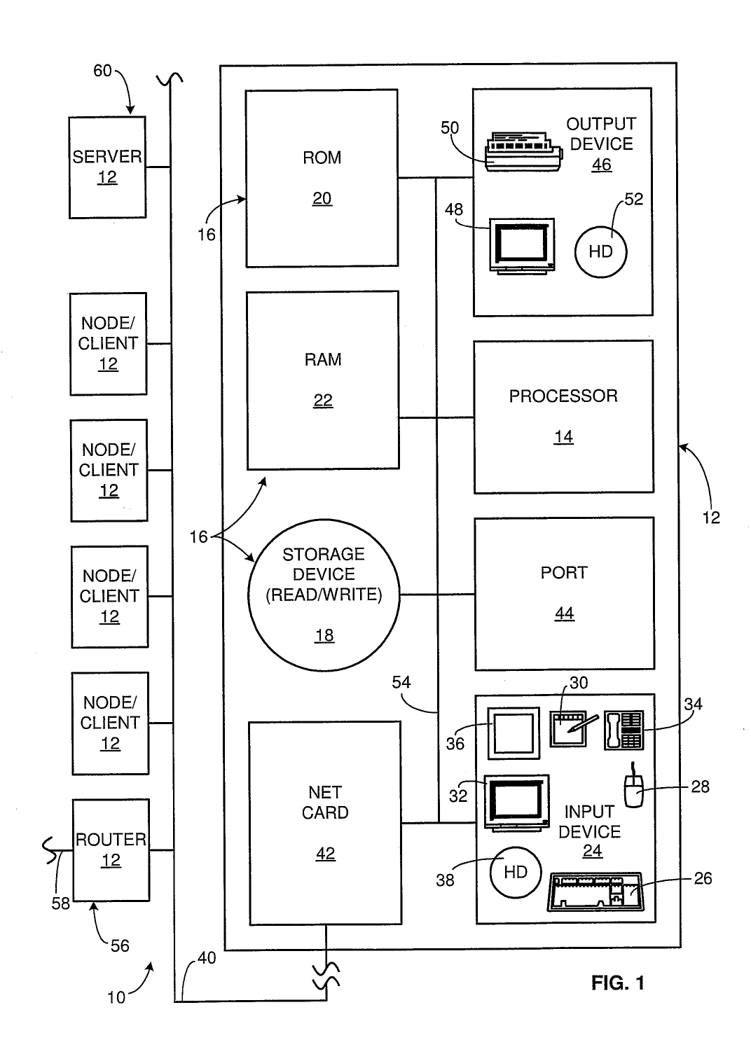

Referring to FIG. 1, an apparatus 10 or system 10 for implementing the present invention may include one or more nodes 12 (e.g., client 12, computer 12). Such nodes 12 may contain a processor 14 or CPU 14. The CPU 14 may be operably connected to a memory device 16. A memory device 16 may include one or more devices such as a hard drive 18 or other non-volatile storage device 18, a read-only memory 20 (ROM 20), and a random access (and usually volatile) memory 22 (RAM 22 or operational memory 22). Such components 14, 16, 18, 20, 22 may exist in a single node 12 or may exist in multiple nodes 12 remote from one another.

In selected embodiments, the apparatus 10 may include an input device 24 for receiving inputs from a user or from another device. Input devices 24 may include one or more physical embodiments. For example, a keyboard 26 may be used for interaction with the user, as may a mouse 28 or stylus pad 30. A touch screen 32, a telephone 34, or simply a telecommunications line 34, may be used for communication with other devices, with a user, or the like. Similarly, a scanner 36 may be used to receive graphical inputs, which may or may not be translated to other formats. A hard drive 38 or other memory device 38 may be used as an input device whether resident within the particular node 12 or some other node 12 connected by a network 40. In selected embodiments, a network card 42 (interface card) or port 44 may be provided within a node 12 to facilitate communication through such a network 40.

In certain embodiments, an output device 46 may be provided within a node 12, or accessible within the apparatus 10. Output devices 46 may include one or more physical hardware units. For example, in general, a port 44 may be used to accept inputs into and send outputs from the node 12. Nevertheless, a monitor 48 may provide outputs to a user for feedback during a process, or for assisting two-way communication between the processor 14 and a user. A printer 50, a hard drive 52, or other device may be used for outputting information as output devices 46.

Internally, a bus 54, or plurality of buses 54, may operably interconnect the processor 14, memory devices 16, input devices 24, output devices 46, network card 42, and port 44. The bus 54 may be thought of as a data carrier. As such, the bus 54 may be embodied in numerous configurations. Wire, fiber optic line, wireless electromagnetic communications by visible light, infrared, and radio frequencies may likewise be implemented as appropriate for the bus 54 and the network 40.

In general, a network 40 to which a node 12 connects may, in turn, be connected through a router 56 to another network 58. In general, nodes 12 may be on the same network 40, adjoining networks (i.e., network 40 and neighboring network 58), or may be separated by multiple routers 56 and multiple networks as individual nodes 12 on an internetwork. The individual nodes 12 may have various communication capabilities. In certain embodiments, a minimum of logical capability may be available in any node 12. For example, each node 12 may contain a processor 14 with more or less of the other components described hereinabove.

A network 40 may include one or more servers 60. Servers 60 may be used to manage, store, communicate, transfer, access, update, and the like, any practical number of files, databases, or the like for other nodes 12 on a network 40. Typically, a server 60 may be accessed by all nodes 12 on a network 40. Nevertheless, other special functions, including communications, applications, directory services, and the like, may be implemented by an individual server 60 or multiple servers 60.

In general, a node 12 may need to communicate over a network 40 with a server 60, a router 56, or other nodes 12. Similarly, a node 12 may need to communicate over another neighboring network 58 in an internetwork connection with some remote node 12. Likewise, individual components may need to communicate data with one another. A communication link may exist, in general, between any pair of devices.

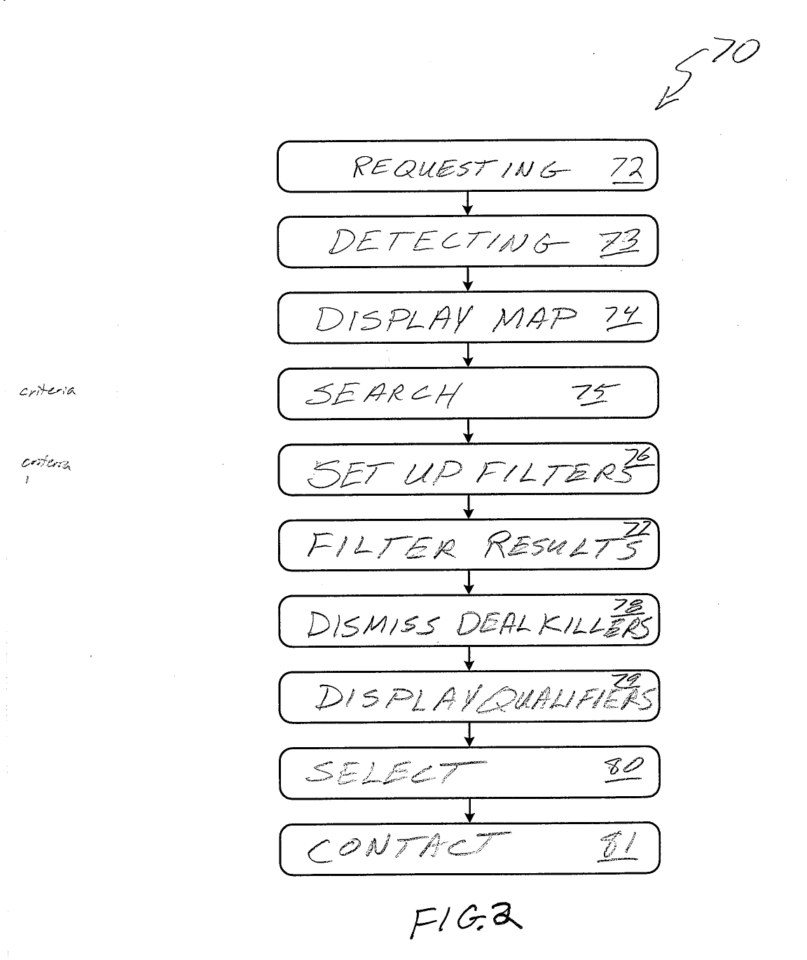

Referring to FIG. 2, an apparatus 10 may support a

An automated electronic travel agent may be provided, for example by means of a handheld device such as a smart phone, GPS receiver, handheld computer, laptop computer, or other similar mobile electronic platform. In the exemplary embodiment, the automated electronic travel agent includes a GPS receiver and wireless network connection. The GPS receiver is configured to be communicatively coupled to a CPU and provide location information to the CPU.

The wireless network interface is also configured to communicatively couple to the CPU and to communicate with a third-party service provider which may provide recommendations for nearby facilities based on the provided GPS location. Advantageously, a user may be enabled to search nearby hotels, motels and other similar facilities by proximity to his or her current location, in specific cities, for a current date or any date range, by brand, franchise, distance, area, and rating.

The user may also be enabled to save preferences in a user profile, so that the automated electronic travel agent can later provide recommendations with minimal input from the user. For example, if the user saved in his user profile a preference for three-star hotels within 15 miles of his present location and with vacancies for the current date, then the automated electronic travel agent can continuously track the user's location based on GPS signals and incrementally update available rooms.

Alternatively, the automated electronic travel agent can update information on command, but with a stored profile may require only a single interaction, such as a single button click. Thus while the user is traveling, he can consult his automated electronic travel agent at any time and easily find suitable facilities near his current location.

The automated electronic touch travel agent as described above also provides an advantageous platform for banner advertising. For example, the third-party service provider may sell advertising space to advertisers based on a number of impressions, and targeted to a specific area. For example, an advertiser located in the zip code 78205 may buy advertising space for consumers who use an automated electronic travel agent while located in or around the 72005 zip code. This will allow, for example, proprietors of hotels and motels in or around downtown San Antonio, Tex. to target consumers while they are in or near San Antonio and are looking for a facility with vacancies.

This also facilitates targeting individuals who have a preference for specific characteristics in a facility. For example, if a user has stored in his profile a preference for a three star hotel with a swimming pool and free Wi-Fi, he may be a less effective advertising target for a one star hotel with no swimming pool or Wi-Fi. The automated electronic travel agent therefore provides a platform for serving relevant advertisements to the users most likely to respond to them.

Referring to FIG. 2, a process 70 in accordance with the invention may include requesting 72 a service. For example, a user may log on to a computer, whether or not that computer is a desktop, a laptop, a personal digital assistant, a smart phone, or any other computerized device. Likewise, typically, such a computer will be connected to a network 40 or an internetwork 58 of computers of others as described hereinabove.

Thus, a user may request 72 a service of a purveyor. This may be done through a third party server 60 providing the search service. Likewise, a user may request 72 a product.

In one embodiment of an apparatus and method in accordance with the invention, a process 70 may begin by a computer associated with a user requesting 72 a particular product or service. This may be done by a menu, a touch screen, icons, or the like. Typically, requesting may involve accessing a server 60 somewhere on a network 58, in the cloud, over the internet 58, or the like. Typically, requesting 72 involves a computer of a user contacting another computer, typically through a browser or an application running on the user's computer 12 or a third party server 60.

Following the request 72, a computer, typically of a third party, but somewhere connected to the internet 58 may detect 73 certain information about the computer 12 generating the request 72. For example, detecting 73 may involve reading or requesting the global positioning system (GPS) location of the computer 12 making the request. In an alternative embodiment, the server 60 may pose a request to a user by sending a question, a query, or the like to the user.

In other embodiments, a user may use a template in an application hosted on the user's computer 12 in which the processor 14 presents menus, choices, or dialogue boxes requesting input. Thereby, a user may provide a location where the user is located, or a location at which the user expects to be in the future Likewise, a GPS system, now typical in most smart phones and cell phones, may be tasked with the responsibility of providing to communication software the GPS coordinates of the very device that is the computer 12 of a user.

Thus, by detecting 73 a location is meant either detecting the location of the device, such as through delivery of GPS coordinates, requesting an input of a current location of a user, or by requesting a future location identified and for which information is needed.

Following detecting 73, the desired location, a system 10 may display 74 a map. Typically, users are familiar with maps. Moreover, the ubiquitous services of companies and products such as MapQuest™ and others provide maps to many websites. Thus, users are familiar with maps, and displaying 74 a map to a user may provide to the user a location, typically identifying the desired location a centerpoint of the surrounding area.

Thus, for example, GPS coordinates may give the anchor point that serves as the center of a screen in a map displayed 74 in accordance with the invention. Similarly, the longitude and latitude of a particular location available by other mapping software may serve as the centerpoint of a map displayed 74 to a user in response to the detecting 73 of a specific location being visited in the future.

In displaying 74 a map, a physical description, a pictorial representation, a schematic representation, or the like may all be suitable. For example, the metro rail system of the District of Columbia relies on a schematic map with which riders have been familiar for decades Likewise, states and cities publish, or have published by others, maps laying out streets, various features, rivers, railroads, and the like in maps available commercially. Thus, by whatever mechanism, displaying 74 a map may display to a user an image that identifies the user's desired location (present or future) and surrounding features significant to that map.

In the displaying 74, a map presented on the computer 12 of the user may be served up by a server 60, far remote from the computer 12 of a user. Likewise, mapping software may be contained within a smart phone or other computational device owned by user. Thus, displaying 74 may be driven by software systems within the user's computer 12, or may simply be delivered to the computer 12 of a user from a server 60 remote across the internet 58 or some other network 40.

The map itself may contain information at various layers. For example, various features of interest, locations of interest, businesses, and the like may be saved for display 74, but may be displayed on demand only. Alternatively, a display 74 may involve presenting geographical information, overlaid with specific feature information, which may then be edited according to queries of a user. For example, displaying 74 may involve displaying only those features that have been requested in accordance with filtering according to queries, desires, or inputs provided by users.

Searching 75 may be instigated by a user interacting with the map displayed 74 by the process 70 and system 10. For example, a user may pick a distance, such as a radius. This selection may be made by inputting numbers, units such as meters, miles, blocks, feet, or the like. Thus, in setting up and executing the search 75, the system 70 may request inputs of a user to identify the type of limitations the user wants to place on the request 72 for a product or service. Typically, these parameters will involve distance of some form. However, they may involve other parameters as well. Thus, initially, the search 75 may simply find products or services available according to the request 72 and within a range of the centerpoint corresponding to the user and shown in the display 74.

Setting up 76 filters may occur before the search 75, after the search 75, during the search 75, or at all of those times and logical positions. For example, a search 75 necessarily includes parameters from the request 72. A user in setting up a search 75 may typically input certain parameters, whether words, locations, numbers, or other parameters that are understood and interpreted by the search 75 to indicate parameters to be sought in some available database.

However, setting up 76 filters is very different in a process 70 in accordance with the invention as compared with prior art systems. Typical prior art systems are maintained by and serve commercial interests of the purveyors of products and services. Thus, in one form or another, commercial websites represent online catalogues of products and services.

Since the days of the Montgomery Ward and Sears catalogues mailed throughout the North American continent, catalogues with their indices, imagery, product descriptions, pricing, order forms, and the like have been ubiquitous. Online catalogues are more ubiquitous than ever. Necessarily, a purveyor of goods and services develops a hierarchy or structure by which to organize, display, and document goods and services. Outlines, lists, levels of detail, and the like represent the classic organization of products and services.

For example, a catalogue may include numerous products. An old Montgomery Wards or Sears catalogue is a classic example. Such catalogues often carried farm and household goods. Such goods included everything from flatware to dishes to appliances to clothing to motorcycles to farm equipment and so forth. Thus, a highest level directory might include machinery, motorcycles, clothing, housewares, and so forth. Under housewares, kitchenware, pots and pans, appliances, and so forth, might be subcategories of kitchen equipment Likewise, bedding might include mattresses, boxsprings, mattresses, sheets, blankets, quilts, bedspreads, and so forth. A logical detailing is a reasonable way to organize catalogued goods and services.

Customers are typically not interested in everything a catalogue has to offer. Customers have specific, timely needs. Customers want satisfaction of their needs. Thus, setting up 76 filters may typically be done by a server 60 operated by a third party that is owned by neither the user associated with the request 72 nor a purveyor associated with the goods that a user has identified in the request 72. Thus, setting up 76 filters in a method 70 in accordance with the invention involves determining parameters and methodologies to sort through not only catalogues of purveyors but sorting through purveyors in accordance with the needs of the customer making the request 72.

For example, it is a simple matter to identify commercial entities, stores, restaurants, service stations, and the like within a specific distance of a specific location detected 73 or identified in a request 72 of a user. The sorting through such a massive amount of information in a large city is so daunting as to approach impossibility.

Likewise, commercial entities, purveyors of goods and services, are interested in selling what they have for sale. Users of computers, accessing servers 60 over the internet 58, are interested in solving their own needs. Thus, the organization of the hierarchy of setting up 76 filters 77 for a search 75 in accordance with the needs of a user is not only different but often antithetical to the organization of catalogues put out by purveyors.

In one embodiment of an apparatus and method in accordance with the invention, setting up 76 filters 77 may involve selection of parameters that matter to a user, a purchaser of goods or services. In addition to geographic proximity, a user may care very much about other characteristics of a product or service. For example, hotels and other lodging services may be graded according to their rating. Hotels advertise that they are three star, four star, five star rated, and so forth.

Similarly, hotels and restaurants will advertise that they have been rated by certain guides such as the Michelin Guide, the Mobil Guide, Fodor's, Zagat, and so forth. Thus, a user may determine that a parameter by which purveyors should be filtered is the quality rating.

Likewise, a user may determine that a particular ownership may be important. For example, Holiday Inn is a respectable chain of lodgings throughout the North American continent. Likewise, the Marriott system of lodging locations is another. Each is respectable in its own right and each has different embodiments of its lodging, with different rankings, ratings, or the like.

Thus, ownership may be important, rating, such as star rating, may be important, and the affiliations may be important. Which guides are affiliated with a particular lodging may be important, as well as which associations. For example, Best Western hotel chain is a chain of independently owned hotels. Thus, Best Western is a brand name but is also an affiliation, and much more variation will be found between specific lodging locations than may be found in, for example, the Hilton hotel chain or the Marriott hotel chain. Thus, the ranking or rating, the affiliations, the guides that provide recommendations, the ownership, and the like may be particular parameters of interest to a particular user.

In addition, setting up 76 filters 77 may involve the more pedestrian filters such as location, proximity to a venue, proximity to certain events, and the like. Similarly, there may be effects of geography that also matter. Whether a hotel is in the mountains, in the city, near a beach, on the beach, or the like may be a geographical effect of the physical location.

Likewise, individuals may care about specific amenities, services, and events associated with or in the proximity of a particular lodging. Thus, a user may determine that proximity to Disney World™, Sea World™, Six Flags™, or the Mall of America™ is important. Similarly, a user may find that particular convention is nearby, or a tradeshow. A specific hotel in Las Vegas may be the site of a convention. Accordingly, a user may find it necessary to attend a convention but may not desire or may not be able to book lodging at the convention hotel.

For example, late arrivals who determine to attend a convention or conference after some cutoff date cannot typically obtain lodging at the convention or conference hotel because the block of rooms is simply no longer reserved or has subsequently filled up. Thus, a user may find that inputting dates as well as other features, amenities, services, events, and proximities, may be important parameters, unique to that user. These parameters are often of little relevance to a particular purveyor of goods or services. That is, a hotel has what it has. It offers what it offers. It may not have a key amenity and will not necessarily want to advertise that it lacks that amenity. However, that amenity may be very important to a particular traveler.

For example, a somewhat rare, but increasingly visible, illness is celiac disease. Individuals affected by celiac disease cannot tolerate gluten. Gluten is a fundamental constituent of certain grains, such as wheat. The special requirements of the diet are now being recognized more widely and accommodated by various restaurants. Such an accommodation may be an important factor to an individual.

Likewise, notwithstanding the Americans with Disabilities Act (ADA), which mandates accessibility, certain numbers of handicap-accessible rooms may be available in a particular hotel. But, if all those handicap-accessible rooms are gone and a user still needs lodging, such a feature and its current availability on the day requested may be a determinative, deal-killer factor.

This principle of whether or not a hotel room or other lodging is available on a specific date, and particularly the very date that the reservation is being made, has been and continues to be a problem with customers seeking lodging. Purveyors advertise all of the rooms with all of their features in their “catalogue,” thus cluttering the world wide web with irrelevant information to one who actually wants a specific but unavailable service.

For example, the day of a meeting, an individual may decide to stay over an extra day. How does one find a room that is still available. It is not uncommon for one to search the Internet, find websites of local hotels, and navigate through the “catalogue” of rooms and features only to find that once all parameters are in, no such rooms are available. The waste of time certainly leads to frustration. That makes not only a frustrated user, but also means that other purveyors of lodging may be able to provide for someone's needs but simply do not have the opportunity, because the user has to search hotel by hotel, website by website, a time consuming prospect.

After setting up 76 filters, the actual process of filtering 77 again may occur. It may occur before the search 75, during the search 75, after the search 75, or at all those times. For example, the search engine conducting the search 75 may actually have these filters set up in it. However, in other embodiments, a third party, independent of the purveyors who have websites, may search out the various websites, and consolidate into a database the information, and needs to be able to filter 77 the results found in a more generic or broad search 75.

Likewise, dismissing 78 deal killer refers to the server 60 or an application operating on a processor 14 of a computer 12 of an individual user. This may be determine based on priority, or on an absolute digital input by a user, requiring that certain features, amenities, or other parameters are required.

For example, a user may determine that a certain price cap is an absolute requirement. In other embodiments a user may determine that a particular quality is required. Thus, a user may input deal killer parameters and values for those parameters that are required in order for a purchase to be acceptable. If those parameter values are not met, then all available results shown by the search 75 that will not meet the deal killer values will be dismissed 78. This greatly narrows the number of purveyors and their websites or personnel with which a potential customer must deal.

The process 70 displays 79 the qualifying entries. At this point, displaying 79 may involve ranking according to the priorities by the user for various factors. For example, some users may pick price as the highest priority parameter. Others may pick hotel quality or quality rating and ranking as the highest priority. In other embodiments, a user may select some other amenity, service, or the like as the highest priority. Likewise, a user may rank priorities, determining the ranking or the weighting of each parameter.

Thus, displaying 79 may be preceded by a processing of the parameters, their ranking or rating, or their weighting. Thus, displaying 79 involves displaying 79 a filtered subset of all available products or services, from various purveyors thereof, and these may be ranked according to numerical rating, order ranking, or a weighting that weighs one parameter or more against another.

For example, in weighting, a processor 14 in a computer 12 of a third party service provider who is conducting the search for a user may obtain from the user that a determination of price is twice as important as quality. Quality is still important, and quality is more important than, say, proximity. In other embodiments, a user may determine that proximity is most important, and maybe 50 percent more important than price, but price is still more important than quality. Thus, with an apparatus and method in accordance with the invention, a user may determine not only the factors that are most important but the ranking or weighting or other relative importance of those factors in order that the user obtain exactly what the user desires.

This concept is antithetical, as described hereinabove, to the typical motivations and operations of websites operated by individual purveyors. Moreover, systems that operate and claim to operate as brokers, such as Orbitz™, Priceline™, and the like are still simply purveyors of a larger number of brand names. They do allow one to select between brands, typically based on price, but do not allow the user to meet all the user's objectives. Users want the most important parameters satisfied at the best price, and some of these parameters are more important than price.

Ultimately, selecting 80 involves a user selecting from the available entries displayed 79. The user may then contact 81 by telephone, by electronic connection provided by the server 60, or by an application running on the computer 12 of a user, in order to make the contact with the purveyor of the product as selected 80.

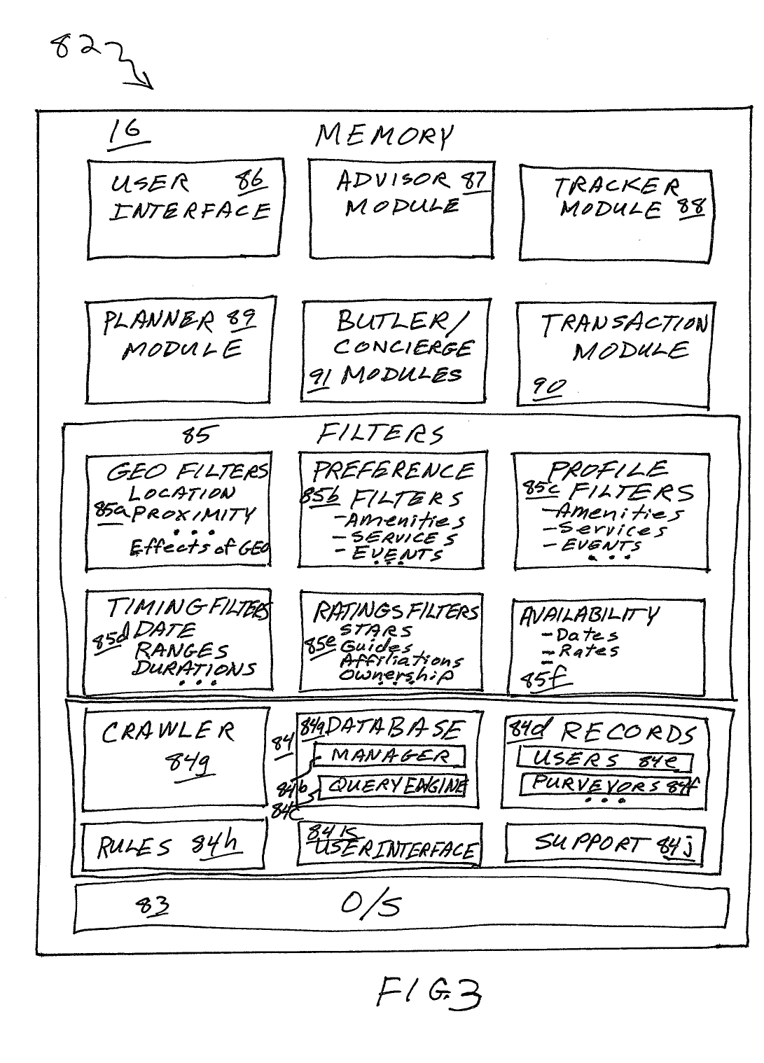

Referring to FIG. 3, a memory device 16 in a computer 12 may be embodied in a computer 12 of an individual user or a computer 12 operating as a server 60 of a purveyor of goods and services, or most typically, in the computer 12 operating as a server 60 of a third party providing a process 70 in accordance with the invention.

Accordingly, the executables stored in memory 16 (a computer-readable, storage medium) may include a database system 84. By database system 84 is meant a system that has the capability to database information, collect the information for that database, store the records involved in that database, search or query that database for information, and provide to users who make those queries a result of satisfactory hits or satisfactory answers in response to queries. In order to do this, a database system 84 may typically involve a database engine 84a. Typically, a database engine 84a may include a manager module 84b responsible to take in information, process information, store information, and administer the like.

Likewise, typically, a query engine 84c handles queries and sets up searches in response to queries. Thus the managing function 84b refers to acquiring, storing, and managing the data, while the query engine 84c is responsible for answering queries by those who access the database for the information contained therein.

Likewise, the database system 84 may include records 84d created by the database engine 84a, including records of individual users 84e that access the database records 84d, purveyors 84f of services and goods that have been identified by the database engine 84a, and the like. For example, records 84d may be associated with any facts, entities, or information that may be of use to users accessing the database system 84. Thus, records 84d, may include records 84d of product information, product sellers, product specifications, individual users, manufacturers, retailers, wholesalers, and the like corresponding to goods and services.

Likewise, the database system 84 may contain or may rely on a crawler 84g, often called a web crawler 84g, that amounts to a specialized search engine 84g that investigates webpages published over the internet and searches them for information. The crawler 84g or post processing software then parses that information and places it into a format suitable to be saved in records 84d that can then be accessed by the database engine 84a, and specifically by the query engine 84c for searches. Thus, the manager 84b will manage the information, put it into records 84d, having received it from the crawler 84g in a recognizable format for the information contained.

Rules 84h may exist to be used or stored within the database 84a, the crawler 84g, or both. For example, a crawler may have rules for distinguishing information and determining its significance and so forth Likewise, the formatting in which information will be placed or the format by which it will be recognized may be included in rules 84h. Likewise the query engine 84c may have rules 84h within it, or may rely on rules 84h imposed upon it.

Typically, a database system 84 will need a user interface 84k to interface with individual users, with other computers, with management personnel who maintain the database 84, and so forth Likewise, other support 84g functions may be included in the database system 84. Much administration is required for the collecting, sorting, storing, organizing, and other administration of information in a database 84.

Filters 85 may provide unique features in accordance with the invention. Particularly, a user has needs sought to be satisfied through online searches for purveyors of goods and services. Various filters 85 may be embodied in an apparatus and method in accordance with the invention. Geographic filters 85a may be filters that identify places, regions, distances, and the like. For example, a specific location of an entity, a user, or a purveyor may be significant. Similarly, a location of a particular venue for a conference, an event, or the like may be important.

Likewise, the proximity of any particular event, location, or purveyor with respect to a conference, a user's current location, or the like may be significant. Similarly, effects of geography may also be significant elements addressable by geographic filters 85a. For example, hills, stairs, obstructions, rivers, and so forth may represent the effects of geography.

For example, someone may wish to be near a lake or a river. The geographic location of a particular hotel having an overlook of the river or other feature may be significant. For example, in New England, fall foliage is a spectacular display some years. Thus, a hotel having a view of fall foliage may be particularly desirable in Massachusetts or Connecticut. Similarly, a small bed-and-breakfast inn on the New England coast may have a view of the ocean. Thus, there may be effects of geography or geographical location that may also form parameters of significance in a geographic filter 85a.

A preference filter 85b may deal with preferences identified by a user. For example, a user may have specific preferences for a specific trip. Certain amenities may be necessary or desirable. Certain services may be absolutely required. For example, a business traveler may require access to internet connections, printers, and other business services in order to conduct business from a hotel during a particular trip. Others may desire only vacation services and amenities, including swimming pools, spas, shows, and the like. By the same token, events that are hosted near or in association with particular venues may also be identified by preferences 85b. Numerous preferences 85b of users may be kept as parametric values to be used in filtering 77.

A profile filter 85c differs from a preference filter 85b in that a profile may be a typical set of parameters or may reflect a typical set of parameters of importance. For example, profiles may be input by users, just as preferences may be. However, in some embodiments, profiles may actually track a user's actual uses of services and goods, and thus reflect in any given search 75 or in any given set of filters 85 the most common parameters and their values that will matter to that user.

Similarly, timing filters 85d may involve dates, date ranges, durations, and so forth. For example, a user may wish to attend a motorcycle rally in Sturgis, S. Dak. However, much of the activity surrounding the Sturgis Motorcycle Rally every summer actually occurs in the week leading up to the rally itself. Similarly, other features, such as a motorcycle museum, other get-togethers between friends, and so forth may also occur in a date range. Thus, an individual may specify a range before, a range after, or a range around a specific event. Similarly, the specific date a user is requesting 72 a good or service may be critical.

Ratings filters 85e may involve such things as star ratings of lodgings, guide associations or the like that have rated a particular hotel, or the like. Similarly, affiliations, including commercial affiliations, or associations of different entities may be included, as well as the ownership of a particular establishment.

For example, if an individual desires to stay only in hotels maintained by the Marriott™ system, they may obtain flagship Marriott™ hotels with the most opulent appointments, or the Residence Inn™ system that is typically farther from commercial centers and more residential in nature. Somewhere between the residential amenities and the opulent uptown hotels may be the Courtyard™ that is not central to the commercial centers but nevertheless reasonably convenient thereto. Thus, an individual may decide to vary on rating but still stay within an ownership system.

Availability filters 85f may be some of the most important to a user. For example, it does no good to do a tour over the internet of hotels advertising in a city. Traveling in large cities, such as New York City, Washington D.C., Philadelphia, Boston, and so forth is no small matter. Likewise, it does no good to see all the wonderful properties and amenities available if an individual needs a hotel right now at ten o'clock at night and most hotels are full. What a user needs at that point is hotels that are first of all available.

Thus, one of the responsibilities of the crawler 84g is to obtain such information from the websites voluntarily or involuntarily. For example, individual purveyors of services and goods may sign up to operate with a third party provider of the services in accordance with the invention. Of course, individual purveyors may implement such a system on their own.

However, the natural tendency of sellers is to sell what they have in stock. Thus, in one embodiment a third party, independent from all purveyors and the user, may be responsible for maintaining the database 84 and populating it with information from the various websites. Availability of rooms on dates, and in some circumstances even by the hour, may be very valuable to a user. Similarly, maintaining availability, and rates actually available, based on actual rooms still available, will permit a purveyor to sell the last room in the hotel. In one embodiment, only hotels having rooms available may be presented 79 or displayed 79 to a user in the method 70 in accordance with the invention. The same may be done based on quality ratings.

In certain embodiments of apparatus and methods in accordance with the invention, software modules may include a user interface 86 for interfacing with the user of a smart phone, computer, laptop, tablet, PDA, or the like. For example, the user interface 86 may be the browser on user's computer, plugins augmenting it, or both. In other embodiments, the user interface 86 may be an application or browser running on a smart phone. In other embodiments, the user interface may be an application downloaded to an individual's computer and operating there. In other embodiments, the user interface 86 may be the presentation provided by a server 60, of the third party services, not of the goods and services themselves, and accessible simply through the browser of a computational device of a user.

In some embodiments, the user interface 86 may be regarded as a client accessing a server 60. In other embodiments, the user interface 86 may simply be the website “face” of a third party provider of the methods and apparatus in accordance with the invention.

In one embodiment, an advisor module 87 may provide advice to a user using artificial intelligence based on the data a user has provided, the queries a user has made, the past history of a user, and so forth. For example, travel agents are not so ubiquitous as they once were. However, the information once available only to travel agents is more available. However, there is still no person nor machine to agglomerate the information the travel agents used to have. Thus, an advisor module 86 or 87 may process information for a user's immediate needs, as well as processing information from previous requests, previous habits, and the like. Thus, an advisor module 87 may provide certain suggestions to a user. In other embodiments, the weather, traffic, and other considerations may be provided by the advisor module 87.

It should be mentioned that the term “executable” as used herein refers to any processable instructions. Typically, individuals are familiar with computer programs, computer applications, and the like Likewise, computer programmers are familiar with individual instructions, routines, libraries, subroutines, and the like. Anything, of any size, executable by a processor 14 is an executable. Typically, executables may be single instructions, groups of instructions, routines, library routines, applications, or the like responsible to accomplish a function.

Thus, rather than saying executable instructions herein, the term executable is used as is done common in the programming community. Thus, each executable may include executable instructions and operational data. For example, in object oriented programming, an object contains executable instructions and attributes that are effectively data to be processed by the executables. Thus, regardless of the programming language or format, an executable represents an instruction or set of instructions processable by a processor 14. A tracker module 88 may track an individual user's activities in the system 10, 70.

For example, an individual may be able to determine preference but after having made selections over a period of time may have an advisor module 87 actually make recommendation based on the saved data that a tracker module 88 has saved over several transactions.

A packaging module may package all the reservations for a trip, an insurance module may obtain trip insurance, and so forth. A price range or price limit, certain amenities, services, and the like may be those that have been typically been the direct result of previous searches. Thus, a tracker module 88 may assist the system 10, 70 to provide such information to a user, but more importantly, perhaps, to use such information to further narrow or filter 77 information to be presented to a user. After all, a user wants information that will be useful. Information is most useful if it is ultimately used.

A planner module 89 may be available to execute in order to assist a user in planning travel. For example, in certain embodiments a user may be searching for an immediate solution for lodging the very day on which it is sought. In other situations, a user may be planning a series of stops and may rely on a planner module 89 to maintain a consistency between \the searches of 75, the filters 85, and so forth, including dates, distances, travel, lodging, and the like. Thus, a planner module 89 may assist in repeatedly doing searches, and doing them in a particular format and order, in order to put together several transactions that will eventually occur.

A butler module 91 may be referred to as a concierge module 91. However, a butler refers to a personal assistant. A concierge is typically a local source of information. A concierge in a hotel is able to know and tell users about available lodging, available services, such as laundering, clothing, and so forth Likewise, in some embodiments of an apparatus and method in accordance with the invention, in butler module 91, may use information from the tracker module 88, as well as inputs from a user, in order to customize services for a particular user.

Rather than just identifying local restaurants, hotels, and the like, the butler module (which may perform a concierge function as well) is responsible for finding and providing the information that is specifically desired, or typically desired, by a specific user. Thus, the butler module 91 may be responsible to keep track of a user's preferences, a user's ratings or rankings of the experiences at certain locations, and thus maintain a hierarchical list of desired or highly rated restaurants in a particular city, close to particular venues. For frequent travelers, a butler 91 may suggest or may satisfy the desires of a user as tailored to the user's habits.

In general, a transaction module 90 is responsible for actually conducting the transaction with a purveyor. The transaction module 90 may work with the user interface 86 in order to obtain information from the user, provide it to the purveyor, and assist in making the transaction.

For example, a transaction module may be responsible to fill in the blanks in a specific online website of a purveyor of services. The transaction module 90 may be responsible to fill in the user information in a reservation page. Likewise, the transaction module 90 will typically be responsible to provide the credit card information and the like that must be input for a transaction.

Thus, the transaction module recognizes that transactions will be occurring on a regular basis. Accordingly, the transactional module 90 may interface with the website of a purveyor of good and services, in order that a user need not spend time keyboarding in the same information in different websites in order to seek rooms, reserve them, provide deposits, make purchases, and so forth.

In some embodiments of an apparatus and method in accordance with the invention, an individual may thus request 72 services and be presented with a display 74 of a map, after detecting 73 by the system a location of interest, present or future, to a user. Accordingly, a search 75 may be conducted for available purveyors, such as hotels for lodging, in accordance with various filters set up 76 by a user.

The filtering 77 may occur as a continuing process, or before, during, or after, or including all three, with respect to a search 75. In some embodiments, certain searches may occur first, such as a proximity search, in order to narrow the numbers of hotels to be considered. However, then an amenity search, or a ratings search, or filters 85 with respect to various timing filters 85d, ratings filters 85e, availability 85f, in particular, or other preference filters 85b may be invoked.

Ultimately, dismissing 78 before displaying 79 to a user the candidate transactions or purveyors, permits a user to much more quickly select 80 from among a much smaller set, about which the user can be fully informed as to those parameters that matter most to that user. Accordingly, a user may contact 81 directly or may use a transaction module 90 executing on the processor 14 of a computer 12 of a user or on the processor 14 of a computer 12 acting as a server 60 for a third party supplier of this service in order to consummate the transaction with the purveyor.

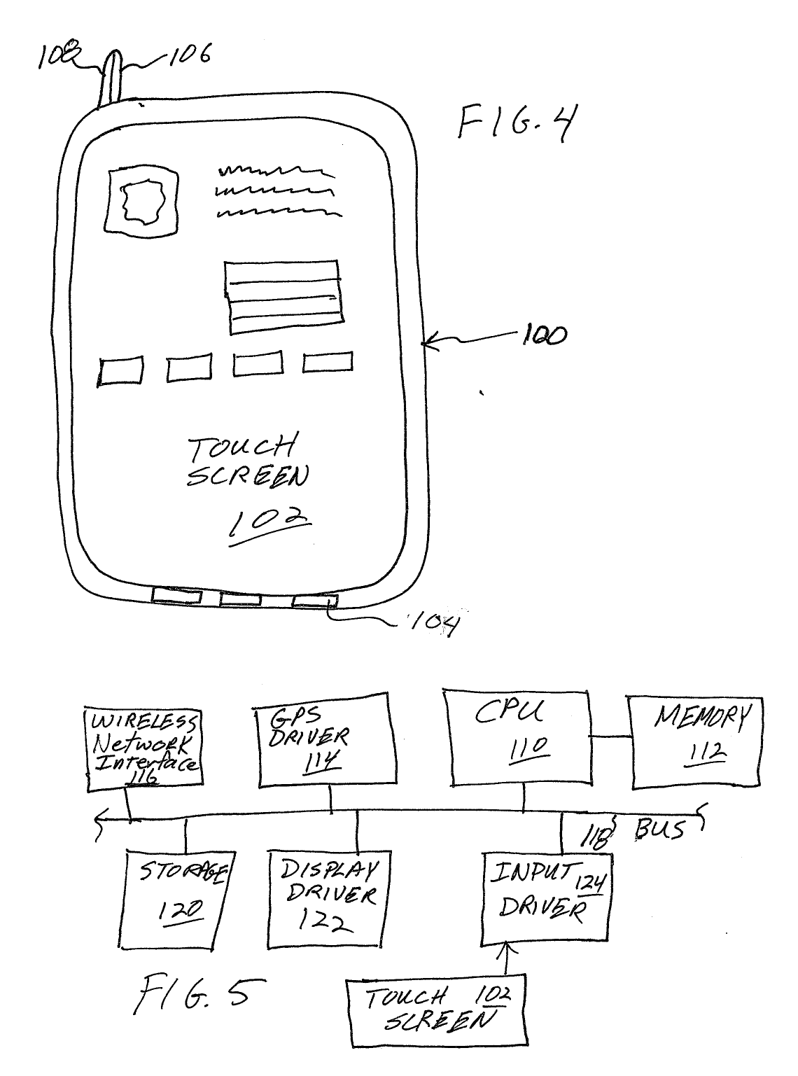

FIG. 4 discloses a front view of a handheld device 100 which may be configured as an automated electronic travel agent. In this exemplary embodiment, handheld device 100 is a smart phone, but maybe any suitable portable electronic computing device, such as a smart phone, personal digital assistant, handheld or palmtop computer, laptop or tablet computer, handheld or portable GPS device, or any other similar device that is functionally similar to the devices described.

By way of example, the disclosed embodiment of a handheld device 100 has a touch sensitive screen 102. The touch sensitive screen 102 is an exemplary embodiment of a combined input and output device. But note that other embodiments may include other combinations of input and output devices, including separately functioning input and output devices, and output devices other than display screens.

For example, an output device may include an audible signal or a text reader for the vision impaired, or a tactile signal such as a vibrating mechanism may be used to indicate the proximity of a desired facility. Also disclosed in this figure by way of example is an additional input device 104, such as a button, buttons, line in, or the like from FIG. 1.

Handheld device 100 is also equipped with a GPS antenna 106 and a wireless network antenna 108. GPS antenna 106 is configured to receive GPS signals, for example from a GPS satellite. Wireless network antenna 108 is configured to communicatively couple handheld device 100 with a wireless network.

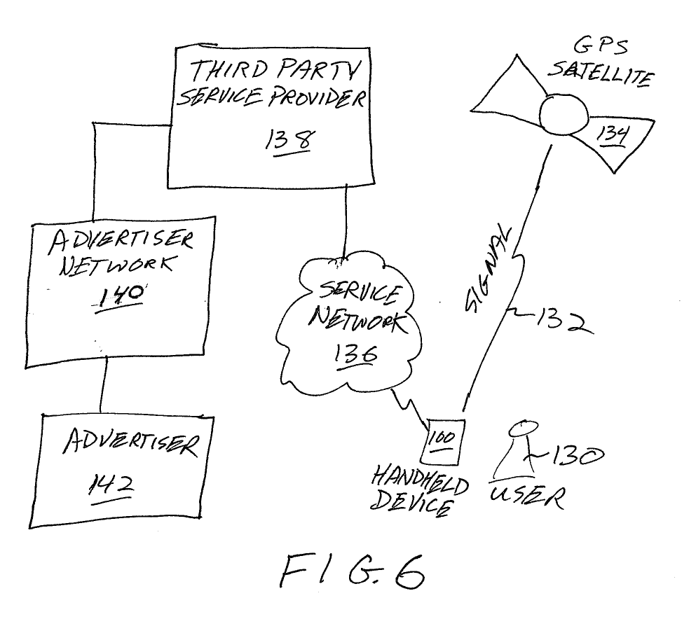

FIG. 5 discloses a block diagram of an exemplary embodiment of internal hardware for handheld device 100. In this exemplary embodiment, handheld device 100 is controlled by a CPU 110. CPU 110 maybe any suitable logic device, for example a central processing unit, graphics processing unit, programmable logic device, field-programmable gate array, or other similar programmable logic device.

Memory 112 is connected in this exemplary embodiment directly to CPU 110 to provide direct memory access. Memory 112 may be a low-latency, non-volatile data medium holding data such as an operating system, and user programs, including a program providing an automated electronic travel agent.

CPU 110 may interface with other peripherals and components via bus 118. CPU 110 is communicatively coupled to GPS driver 114, which receives and processes GPS signals for use by CPU 110. CPU 110 is also communicatively coupled to a wireless network interface 116. Wireless network interface 116 handles input and output signals with a wireless network, thereby communicatively coupling CPU to the wireless network.

CPU 110 is also communicatively coupled to storage 120, which may be a nonvolatile storage medium, and in the exemplary embodiment has a higher latency than memory 112. In some computing devices, memory 112 and storage 120 may comprise a single physical device, and memory 112 may require battery input to maintain stored information.

In other exemplary embodiments, storage 120 may be a truly nonvolatile storage device, such as a hard disk drive, flash memory, or other similar data storage technology as described in FIG. 1. CPU 110 is also communicatively coupled to display driver 122 and input driver 124. Display driver 122 and input driver 124 are further communicatively coupled to touch-sensitive screen 104.

In this exemplary embodiment, input driver 124 receives input signals from touch-sensitive screen 104 and provides the signals in suitable fashion to CPU 110. Also in this exemplary embodiment, display driver 122 receives a signal from CPU 110 and provides output signals to touch-sensitive touch sensitive screen 104. This configuration provides an example of effective input and output with a user.

FIG. 6 discloses a network-level diagram of an automated electronic travel agent in communication with other network components. In particular, a user 310 operates handheld device 100. Handheld device 100 receives a GPS signal 132 from GPS satellite 134. Note that while the exemplary embodiments disclose a GPS satellite 134, technological improvements may provide non-satellite means for global positioning, and the present disclosure is intended to encompass any such improvements in global positioning technology.

Handheld device 100 is also connected to service network 136, which provides communication with third-party service provider 138. Service network 136 may be a dedicated network, such as a wireless cellular network, a wireless Internet service, or other similar wireless service providing bi-directional communication between handheld device 100 and third-party service provider 138.

Third-party service provider 138 may maintain and update a facility database, including real-time or near-real-time updates of member hotels and motels, vacancies, rates, available amenities, and other similar useful statistics. Third-party service provider 138 may thereby provide relevant and timely information to handheld device 100.

For example, handheld device 100 may provide its current global position based on GPS signal 132, and third-party service provider 138 may consult its database to provide a list of available facilities within a specified radius of the present global position. Third-party service provider 138 may also be connected to advertisers 142 via an advertising network 140. Advertising network 140 may be a dedicated wired or wireless network, and in some cases may be a unified service sharing software, hardware, or both with service network 136. For example service network 136 and advertiser network 140 may both be hosted over the internet from one or more hardware systems and one or more software systems.

Third-party service provider 138 may provide a template for advertisements to advertiser 142. Advertiser 142 can then fill in the relevant information and advertisements, and may buy a specified number of impressions or banner advertisements based on advertising preferences. For example, advertisers 142 may prefer to advertise to users in the 78205 zip code who have expressed a preference for a two-star hotel with a swimming pool and available Wi-Fi service. When third-party service provider 138 detects that a user is in or near the 78205 zip code, and in particular if user 130 has expressed a preference for a two-star hotel with a swimming pool and available Wi-Fi service, third-party service provider 138 may provide that user the advertisement from advertiser 142.

While the subject of this specification has been described in connection with one or more exemplary embodiments, it is not intended to limit the claims to the particular forms set forth. On the contrary, the appended claims are intended to cover such alternatives, modifications and equivalents as may be included within their spirit and scope.

The present invention may be embodied in other specific forms without departing from its basic components or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed and desired to be secured by United States Letters Patent is:

1. A method comprising:
providing a processor corresponding to a first computer;
providing a medium operating as a computer-readable storage medium, operably connected to the processor;
selecting a network configured to interconnect computers for inter-computer communication;
connecting the first computer to the network to communicate with a second computer corresponding to a purchaser;
connecting the first and second computers over the network;
storing on the medium executables executable by the processor;
presenting by the second computer an image corresponding to a user interface;
receiving through the user interface a request for a product, comprising at least one of goods and services;
the receiving, further comprising receiving a value of a filter parameter, the filter parameter reflecting at least one of a rating for quality and actual availability;
searching published information from purveyors of the product to determine candidate purveyors each corresponding to an instance of a third computer;
filtering candidate purveyors based on the filter parameter to determine responsive purveyors complying with the filter parameter; and
presenting to the user computer the product available from the responsive purveyors.

2. The method of claim 1, further comprising, selecting by a user a selected purveyor from the responsive purveyors.

3. The method of claim 2, further comprising contacting, by the second computer, a third computer corresponding to the selected purveyor.

4. The method of claim 3, further comprising, selecting by the second computer a first location selected from the current location of the second computer and a future location identified, by the user, to the second computer.

5. The method of claim 4, further comprising displaying on the second computer a map, provided from the first computer and illustrating an indicator identifying locations of advertised purveyors advertising the product and located within a selected portion of the map with respect to the first location.

6. The method of claim 5, providing by the second computer to the first computer a deal-killer parameter reflecting a requirement selected by a user as non-negotiable.

7. The method of claim 6, wherein filtering further comprises deleting from the displaying all candidate purveyors not complying with a threshold value selected by the user for the deal-killer parameter.

8. The method of claim 7, wherein the deal-killer parameter further comprises at least one of rating, current availability, and cost.

9. The method of claim 1, further comprising contacting, by the second computer, the third computer corresponding to the selected purveyor, automatically upon selection of the selected purveyor by the user.

10. The method of claim 9, further comprising storing, by the second computer, and inputting automatically to the third computer, by the second computer, user information effective to complete a commercial transaction between the user and the selected purveyor for exchange of the product.

11. An article comprising a computer readable storage medium storing data structures comprising executables executable on a processor and operational data, the data structures comprising:
a user interface module for communicating with a user computer;
a database storing records corresponding to products and purveyors of the products;
a crawler providing to the database, automatically, purveyor data and product data published by the purveyors;
a filter module comprising filter parameters and programmed to receive values reflecting criteria selected by the user computer;
the filter module, further programmed to limit purveyors identified to the user computer according to the values;
the user interface module, further programmed to display to a user compliant purveyors, a subset of the purveyors based on the criteria; and
a transaction module programmed to execute a transaction between the user computer and a purveyor computer based on a selection by the user from the compliant purveyors.

12. The article of claim 11, further comprising a tracker module monitoring and tracking purchases transacted by the transaction module.

13. The article of claim 11, further comprising a butler module saving information corresponding specifically to transactional data corresponding to purchaser.

14. The article of claim 11, further comprising a ratings filter effective to filter records from the database in accordance with quality rating values input to the user interface.

15. The article of claim 14, further comprising an availability filter effective to prevent the user interface from presenting to a user at least one of advertising and transaction information corresponding to a purveyors based on the values.

16. The article of claim 15, wherein the availability filter is further effective to prevent presentation to the user interface module information corresponding to purveyors not satisfying the values.

17. The article of claim 15, wherein the availability module is effective to prevent transactions by the user interface module and a purveyor computer, based on the values.

18. The article of claim 11, further comprising at least one of preference filters and profile filters executable to control selection of purveyor records from the database and presented to the user interface based on at least one of purchaser inputs received by the user interface from a purchaser and user purchase history data obtained from previous transactions completed by the user interface module.

19. The article of claim 11, further comprising a tracker module monitoring transactions completed by the user interface module.

20. An apparatus comprising:
a first computer comprising a processor operably connected to a memory, the processor creating, hosting, and operating a database having records stored in the memory;
a second computer, corresponding to a user and operably connected over a network to the first computer;
a plurality of third computers corresponding to purveyors of a product and presenting information corresponding to the product;
the first computer further programmed to create product records and purveyor records in the database containing information obtained by the first computer from the plurality of third computers;
the first computer, further programmed to provide a plurality of filters capable of receiving filter values corresponding thereto selectable by the second computer to control searches of the records;
the first computer further programmed to provide to the second computer access to the database, provide criteria and user values selected by a user as the filter values, and provide to the second computer identification of candidate purveyor computers in accordance with the filter values;
the first computer, further programmed to receive from the second computer selection data selecting a selected purveyor computer from the candidate purveyor computers;
the second computer, wherein the filter values correspond to at least one of quality rating and actual availability; and
the first computer, further programmed to delete from presentation to the second computer presentation of the purveyor information not corresponding to the candidate purveyors and the product.
